(19) United States
(12) Patent Application Publication
(10) Pub. No.: US 2012/0103237 A1
(43) Pub. Date: May 3, 2012

(54) TILTABLE MULTIPLE-STAGED COAL BURNER IN A HORIZONTAL ARRANGEMENT

(76) Inventors: Ronny Jones, Exeter, PA (US); Alan E. Paschedag, West Caldwell, NJ (US); Joseph P. Malone, Stroudsburg, PA (US)

(21) Appl. No.: 12/938,911

(22) Filed: Nov. 3, 2010

(51) Int. Cl. F23B 90/00; B23P 11/00

(52) U.S. Cl. 110/297; 29/428; 431/350

(57) ABSTRACT

Horizontally arranged burners for boiler furnaces are provided where each burner includes a fuel nozzle surrounded by a secondary air outlet. The fuel nozzle and secondary air outlets may tilt in tandem with respect to an air plenum supplying inner secondary air and a fuel carrier providing fuel. Also provided are outer secondary air buckets that may independently tilt with respect to a frame connected to the air plenum. This arrangement can be installed as a retrofit in a conventional horizontal furnace system or in a newly built system. The fuel nozzle and secondary air outlet, and secondary air buckets may all tilt in unison or may all tilt independently. The tilting assists with optimizing a flame temperature profile within the furnace.

### BACKGROUND OF THE INVENTION

The present invention relates to the field of utility furnaces for use in boilers, and particularly to furnaces with horizontally arranged burners.

It is well known that pulverized fuel must be combined with air to enable a flame. Optimizing the physical parameters associated with combining the air and fuel is critical for efficient and safe operation of utility furnaces.

Conventional furnaces with horizontally arranged burners can use tiltable solid fuel nozzles that essentially aim the pulverized solid fuel at a specific portion of the boiler while air buckets provide combustion air. This arrangement allows for some control of the flame position in the furnace, which may help to improve the heat transfer characteristics of the boiler.

Other conventional furnaces include multiple tiltable burners arranged in a vertical frame. Here, the burners are arranged in a column and all move in tandem. This arrangement may also assist with flame control.

### BRIEF SUMMARY OF THE INVENTION

The horizontal arrangement with non-tiltable solid fuel nozzles has been found to result in delayed combustion and poor flame attachment which leads to flame instability. Furthermore, the arrangement does not allow proper air swirl to occur, but rather promotes turbulence at the start of the flame which leads to high NOx emissions.

The vertical arrangement requires a specialized furnace that cannot be reasonably retrofitted in a turbo-fired furnace.

To account for these deficiencies, the current invention provides for an improved furnace with horizontally arranged burners. This arrangement can be installed as a retrofit in a conventional horizontal furnace system, or in a newly built system. The improved burner arrangement provides a secondary air zone that swirls secondary air around the fuel outlet while tilting in tandem with the fuel outlet. In addition to providing air swirl, having an air zone in close proximity to the fuel outlet promotes quicker combustion which improves the heat profile of the boiler. The present invention provides for the option of additional secondary air buckets that may tilt with the fuel outlet.

In a coal furnace, the inventive coal burner can provide optimized coal combustion in addition to better control of flame location through dynamic tilting of the various fuel and air sources. While particular tilt angles for the various components of burners within a furnace may prove optimal during initial testing, through time the parameters that lead to this optimal setting may drift, or changes in the system such as the provision of a different fuel may alter the parameters. The burners may therefore be dynamically tilted to regain optimal performance. This novel arrangement provides an improved means for maintaining optimal flame profile, leading to reduced NOx, CO, unburned carbon emissions, and boiler efficiency.

In one embodiment of the present invention, a horizontal fuel burner comprises a fuel carrier formed from a fuel barrel and a fuel nozzle, the fuel carrier transporting solid fuel and primary air to a furnace. The fuel nozzle is tiltable about a first axis of rotation formed at the junction of the fuel barrel and tiltable fuel nozzle. The fuel burner also includes an inner secondary air plenum through which the fuel carrier extends, and an inner secondary air outlet opened to the inner secondary air plenum such that inner secondary air may travel through the inner secondary air plenum and into the inner secondary air outlet. The inner secondary air outlet tilts with and forms an annular space around the tiltable fuel nozzle such that inner secondary air may exit the fuel burner with solid fuel and primary air from the fuel nozzle.

The horizontal fuel burner may further comprise a first outer secondary air bucket, the first outer secondary air bucket being tiltable about a second axis of rotation. The horizontal fuel burner may additionally comprise a second outer secondary air bucket, the second outer secondary air bucket being tiltable about a third axis of rotation. The burner nozzle and inner secondary air outlet, the first outer secondary air bucket, and the second outer secondary air bucket, may each be tilted at angles of between −20° and 20°. The burner nozzle and inner secondary air outlet, the first outer secondary air bucket, and the second outer secondary air bucket may each be tilted at the same angle.

The horizontal fuel burner may further comprise a plurality of vanes between the burner nozzle and the inner secondary air outlet.

The nozzle may form a burner nozzle socket configured to accept a portion of the fuel barrel.

The inner secondary air outlet may be connected to a perforated plate, which may span between the inner secondary air outlet and outer secondary air spring plates, the perforated plate having perforations, the perforations permitting inner secondary air to exit the horizontal fuel burner. The perforated plate may be curved within the frame and the horizontal fuel burner may further comprise spring plates against which the curved perforated plate may ride during movement thereof. The perforated plate may not be perforated in portions that may contact the spring plates. Alternatively, there may be a division plate against which the spring plate and perforated plate ride, or the spring plate and perforated plate may ride directly against the inner secondary air plenum.

The second outer air bucket may be mounted to a frame on an opposite side of the burner nozzle from the first outer secondary air bucket. The opposite sides may be above (topside) and below (bottom side) the burner nozzle in relation to the furnace.

The horizontal fuel burner may further comprise a tilting mechanism for tilting at least one of the burner nozzle and the inner secondary air outlet, first outer secondary air bucket, and second outer secondary air bucket.

The fuel may be solid fuel.

The fuel nozzle may include a center pipe mounted therein, the center pipe providing a separate path for fuel and primary air to flow within the fuel nozzle.

The horizontal burner may further comprise an inner secondary air pipe surrounding the fuel barrel such that an annular space is created therebetween, the inner secondary air pipe including a perforated section permitting air to enter the annular space. When so provided, the inner secondary air pipe may extend to the inner secondary air plenum to provide inner secondary air thereto. The horizontal burner may also further comprise a collar slidably engaged to the inner secondary air pipe for adjusting the exposed surface area of the perforated section.

The horizontal burner may further comprise spring plates associated with the first axis of rotation. Inner secondary air may be prevented from passing the spring plates.

In another embodiment of the present invention, a method of assembling a horizontal burner may comprise mounting an inner secondary air outlet with internal fuel nozzle to a fuel carrier at a first axis of rotation such that the inner secondary air outlet and fuel nozzle may tilt with respect to the fuel carrier about the first axis of rotation, mounting a first outer secondary air bucket to the frame at a second axis of rotation such that the first outer secondary air bucket may tilt with respect to the frame about the second axis of rotation, and mounting a second outer secondary air bucket to the frame at a third axis of rotation such that the second outer secondary air bucket may tilt with respect to the frame about the third axis of rotation.

The method may further comprise attaching a tilt mechanism for tilting at least one of the inner secondary air pipe, first outer secondary air bucket, and second outer secondary air bucket.

The method may further comprise mounting a secondary air plenum such that air may flow from the inner secondary air plenum to the inner secondary air outlet.

In a further embodiment of the present invention, a boiler system may comprise a furnace and a plurality of horizontal burners supplying fuel and air to the furnace. The plurality of burners may each comprise a fuel carrier comprising a fuel barrel and a tiltable fuel nozzle, the fuel nozzle being tiltable about an end portion of the fuel barrel, an inner secondary air plenum through which the fuel carrier extends, and an inner secondary air outlet open to the inner secondary air plenum, the inner secondary air outlet surrounding the fuel nozzle and being tiltable therewith.

The boiler system may further comprise first and second outer secondary air buckets, the first and second outer secondary air buckets being tiltable. The first and second outer secondary air buckets may be independently tiltable in relation to the frame. The first and second outer secondary air buckets may be mounted above and below the fuel nozzle, respectively, within the furnace.

In yet another embodiment of the present invention, a burner nozzle for a solid fuel furnace may comprise an inlet end and an outlet end, the outlet end forming a plurality of lobes, and an inner pipe mounted between the inlet end and the outlet end, the inner pipe forming an annular space with the burner nozzle. Fuel and air may pass both within the annular space and the inner pipe.

The burner nozzle may be provided with a boss through which a pin may be driven and about which the burner nozzle may tilt.

Fuel and air may passing both within the annular space and the inner pipe may mix prior to exiting the burner nozzle.

### BRIEF DESCRIPTION OF THE DRAWINGS

The above description, as well as further objects, features and advantages of the present invention will be more fully understood with reference to the following detailed description of the coal burner when taken in conjunction with the accompanying drawings, wherein:

FIG. 1 depicts a schematic drawing of a partial side view of a tiltable burner according to the present invention;

FIG. 2 is a frontal view of a burner nozzle forming a portion of the tiltable burner of FIG. 1;

FIG. 3 is a cross-sectional side view of the burner nozzle forming a portion of the tiltable burner of FIG. 1;

FIG. 4 is a side view of the burner nozzle of FIG. 3;

FIG. 5 is a side view of a burner barrel forming a portion of the tiltable burner of FIG. 1;

FIG. 6 depicts a cross-sectional view of the fuel pipe at the first axis of rotation;

FIG. 7A depicts a cross-sectional view of the tiltable burner of FIG. 1 in the neutral position;

FIG. 7B depicts a cross-sectional view of the tiltable burner of FIG. 1 in the tilt up position;

FIG. 7C depicts a cross-sectional view of the tiltable burner of FIG. 1 in the tilt down position;

FIG. 8A depicts a flame temperature profile of a conventional furnace;

FIG. 8B depicts a flame temperature profile of a furnace utilizing the tiltable burner of FIG. 1 in the neutral position;

FIG. 8C depicts a flame temperature profile of a furnace utilizing the tiltable burner of FIG. 1 in the tilt down position;

FIG. 8D depicts a flame profile of a furnace utilizing the tiltable burner of FIG. 1 in the tilt up position.

### DETAILED DESCRIPTION

The patent or application file contains at least one drawing executed in color. Copies of this patent or patent application publication with color drawing(s) will be provided by the Office upon request and payment of the necessary fee.

In describing the preferred embodiments of the subject matter illustrated and to be described with respect to the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

It will be appreciated that the present invention is directed toward providing optimized combustion of pulverized coal or other solid fuels in utility furnaces by controlling the angle of fuel and secondary air entrance among other parameters. This ability is particularly applicable to furnaces that require control of parameters such as steam temperature and solid fuel residence time, but which do not have burners arranged vertically. The tilting procedure may be conducted at the initial startup of a furnace and/or at any time thereafter where a change in the flame temperature profile is desired.

Thus, the present invention provides for an improved burner within a furnace providing a secondary air zone that swirls secondary air around the fuel outlet while tilting integrally with the fuel outlet. The present invention also provides for additional secondary air that indirectly tilts with the fuel outlet.

Typical boilers may include a series of one or more horizontally arranged burners within a furnace. In practice, there are often multiple burners per furnace with an equal number on each side. While the present invention permits for use of various numbers of burners, only a single burner will typically be described below. It is to be understood, however, that multiple numbers of such burners may be employed in a particular furnace. Further, each such burner may be individually controlled.

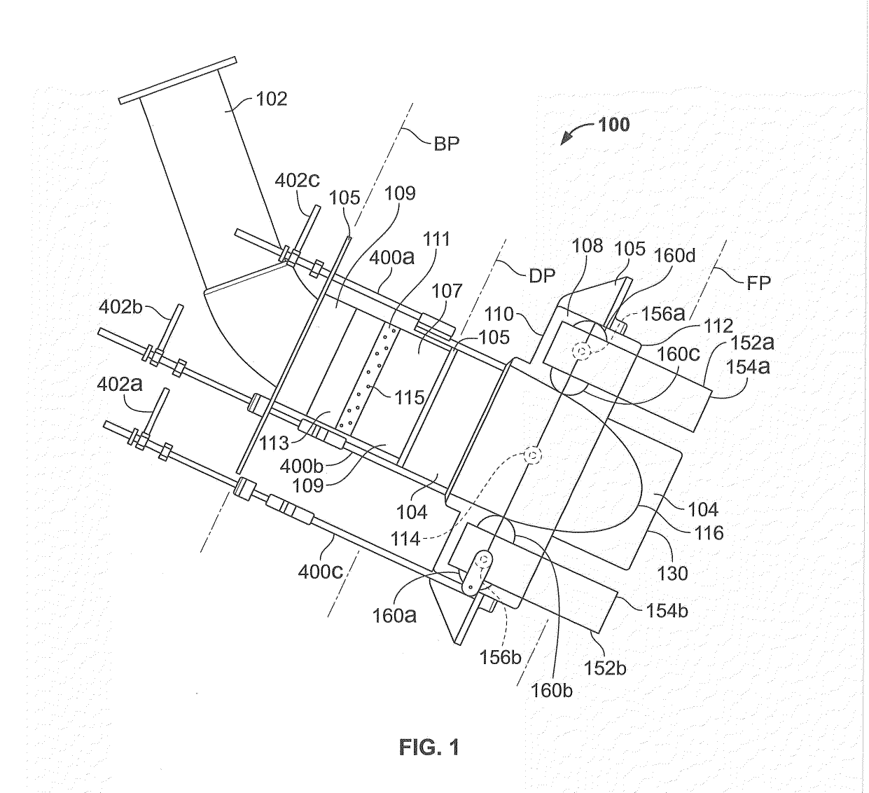

Referring to the drawings, wherein like reference numerals represent like elements, FIG. 1 depicts a schematic drawing of a partial side view of a tiltable burner 100 in accordance with one embodiment of the present invention. It will be appreciated that burner 100 is generally discussed as a coal burner, but the invention includes the use of other solid fuels, such as petroleum coke or co-fired biomass and coal.

It will also be appreciated that the tiltable burner may be installed as a retrofit to an existing horizontal furnace system or as a new installation. For reference, FIG. 1 depicts the tiltable burner 100 as a retrofit within an existing windbox back plate (BP) and front plate (FP), the front plate typically being at the furnace tube wall. Also shown for reference is an existing windbox divider plate, generally providing a barrier between inner and outer secondary air provided to the windbox.

The tiltable burner 100 includes a fuel pipe 102, also referred to as a fuel carrier or coal carrier, through which pulverized coal and primary air may flow in generally the conventional manner. The fuel pipe 102 is preferably circular and extends through an inner secondary air plenum 104. The inner secondary air plenum 104 is a pressurized housing formed from a structural steel frame 105 with steel plates mounted thereon. Note that for clarity not all portions of the structural steel frame 105 and plates are shown in FIG. 1. Opening into the inner secondary air plenum 104 is an inner secondary air pipe 107 which circumscribes the fuel pipe 102 within the plenum leaving an annular space between the fuel pipe 102 and the inner secondary air pipe 107.

The inner secondary air pipe 107 includes, among others, three components, pipe portions 109, a perforated section 111, and a damper section 113. The pipe portions 109 represent the most upstream and downstream sections, with both sections formed as standard piping. The pipe portions 109 are welded to and bracket a perforated section 111 which is also a generally cylindrical section, but which includes a plurality of perforations 115 for allowing air to flow therethrough. As viewed such as in FIG. 1, the inner secondary air pipe 107 includes a pipe portion 109, a perforated section 111, and then another pipe portion 109. The damper section 113 is a short cylindrical pipe or collar which is adapted to slide with respect to the perforated section 111 and pipe portions 109 such that the number of exposed perforations 115 may be controlled. Specifically, the damper section 113 slidingly engages the perforated section 111 and pipe sections 109 so it may be slid to reveal or conceal perforations 115. Of course, the greater the surface area of exposed perforations 115 the greater the air flow through the inner secondary air pipe 107. In other embodiments, the perforated section 111 may be at the end of the secondary air pipe 107 and not bracketed by pipe portions 109, but rather leads into a single pipe portion.

The inner secondary air pipe 107 ends at the inner secondary air plenum 104. Thus, pressurized air flowing through the perforations 115 of the perforated section 111 flows through the inner secondary air plenum 104. As will be discussed below, this air eventually exits the inner secondary air plenum 104 through the fixed vane spinner 125 and the perforations 118 in the spring plate 120a-120d. However, as will be discussed, the ending of the inner secondary air pipe 107 within inner secondary air plenum 104 permits the inner secondary air to be directed at various angles with respect to the second frame 108. This tilting occurs about a first axis of rotation 114.

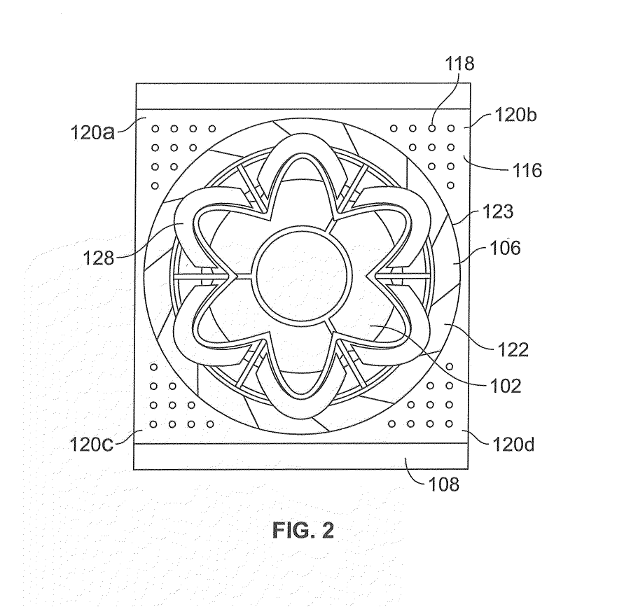

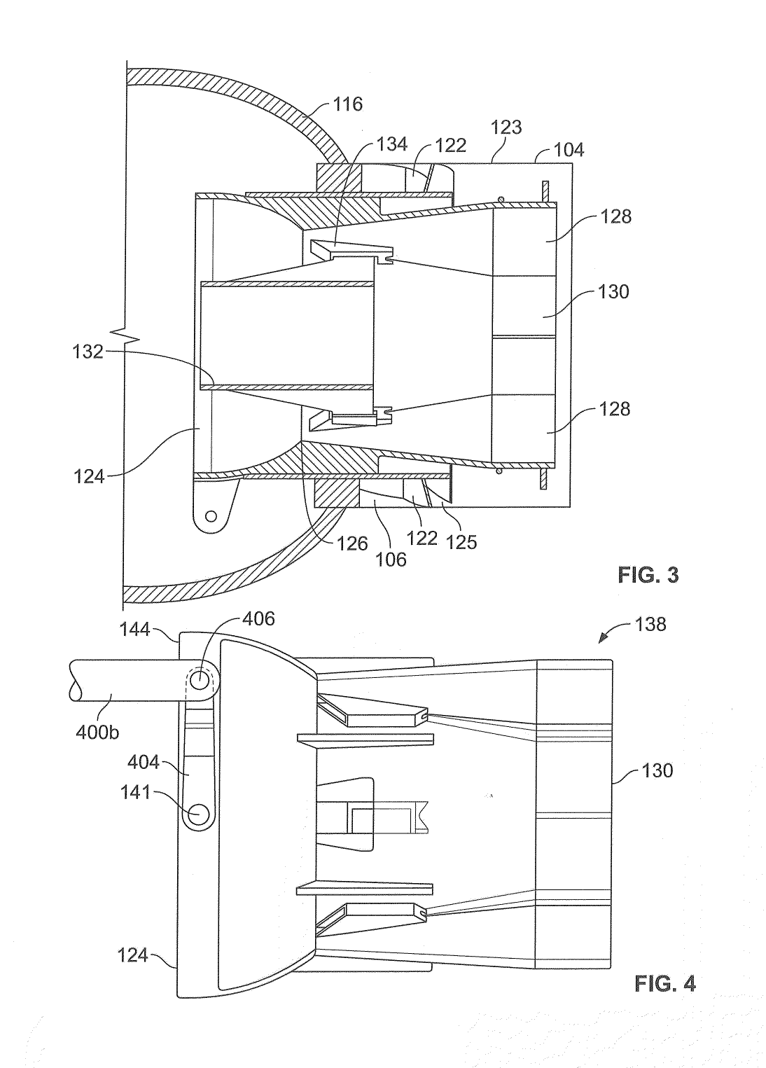

Referring to FIGS. 2 and 3 in conjunction with FIG. 1, there is shown an inner secondary air outlet 123, generally a rolled plate, connected to a perforated plate 116 that spans from the inner secondary air outlet to the inner secondary air plenum 104. The perforated plate preferably includes a series of apertures, or perforations 118, through the plate. Such perforations 118 may be sized and spaced so as to provide sufficient cooling to all parts of the plate while limiting air leakage to the furnace. Preferably, the perforated plate 116 is curved as shown in FIG. 1.

As shown in FIG. 2, the perforations 118 may be located in four quadrants 120a-120d about the inner secondary air outlet 123. Air passes through the perforations 118 from the inner secondary air plenum 104.

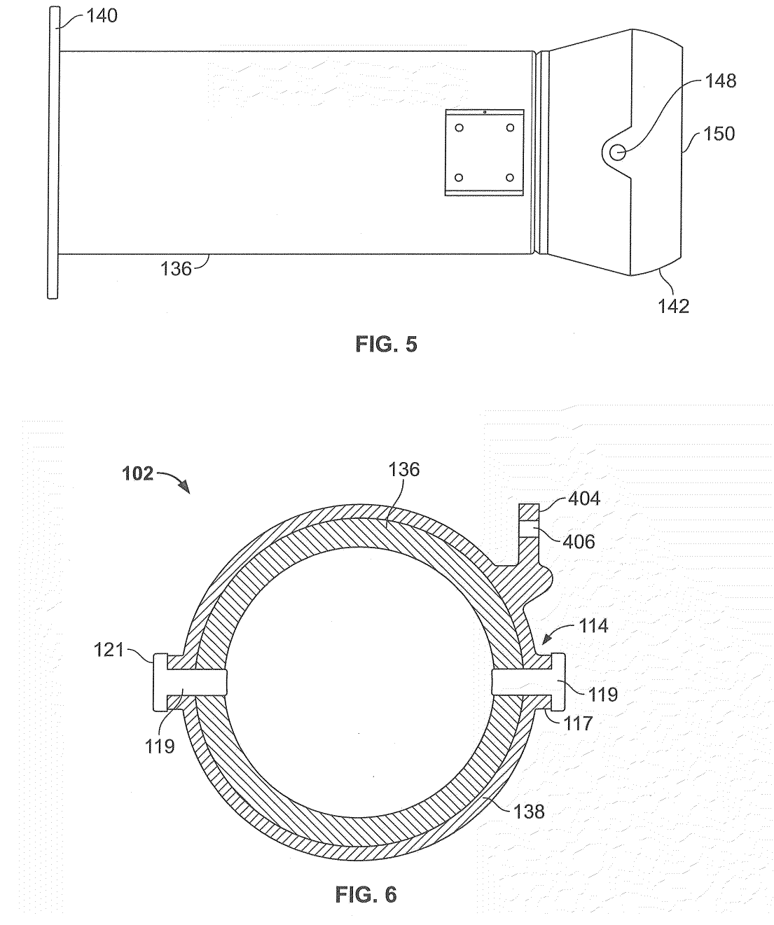

FIGS. 4 and 5 depict side views of the fuel injector portion of the fuel pipe 102 in an exploded condition, with the burner barrel 136 shown in FIG. 5 and the burner nozzle 138 shown in FIG. 4. The burner nozzle 138 depicted in FIG. 4 represents the fuel injector from the burner nozzle socket 124 to the outlet 130. The burner barrel 136 depicted in FIG. 5 represents an upstream section of the fuel pipe 102 from an arbitrary start point with a flange 140 to a burner barrel ball 142.

The cylindrical fuel pipe 102, and specifically the burner barrel 136, enters the burner nozzle socket 124 of the burner nozzle 138. The fuel pipe 102 abuts a stop 126 formed within the burner nozzle 138 allowing coal and other solid fuels to pass from the burner barrel 136 to the burner nozzle. From the stop 126, the burner nozzle 138 forms a series of lobes 128 arranged circumferentially around the outlet 130 of the fuel pipe. The lobes 128 flare from a reduced diameter area to a larger diameter and assist with forming an outlet shape of the pulverized coal and primary air mixture. The lobes also serve to provide the pulverized coal and primary air mixture in a condition suitable for mixing with swirling inner secondary air exiting an annular space 106 formed at a fixed spinner 125.

Mounted within the burner nozzle 138, beginning in the burner nozzle socket 124 section and ending approximately where the lobes 128 begin to form, is a center pipe 132. The center pipe 132 is offset from the walls of the fuel pipe 102 by structural holders 134. The center pipe 132 is preferably cylindrical and serves to permit the pulverized coal and primary air mixture to pass thereby providing a separate path for the pulverized coal and primary air to flow within the burner nozzle 138. This arrangement further aids with delivering the mixture to the outlet 130 in a condition suitable for mixing with swirling inner secondary air exiting the annular space 106. Specifically, this center pipe 132 helps to keep the fuel mixture flow centered within the burner nozzle 138 when the burner nozzle is tilted.

Given the foregoing structure, it will be appreciated that as the pulverized coal and primary air mixture flows through the burner barrel 136, a portion of the mixture is forced through the burner nozzle socket 124 and through the lobes 128 to the outlet 130. In the meantime, a second portion, that which is generally flowing in the center of the burner barrel 136, is forced through the center pipe 132 and also into the lobes 128, where it may again mix with the previous portion as it flows to the outlet 130.

In the meantime, inner secondary air flows through the vane 122 filled annular space 106 of the fixed spinner 125. This secondary air mixes with the pulverized coal and primary air mixture as the mixture exits the outlet 130.

As has been discussed, the burner nozzle 138 is located within an inner secondary air outlet 123 forming a flow divider such that an annular space 106 is formed around the burner nozzle 138. Within the annular space 106 are a series of vanes 122 arranged along the outer perimeter of the fuel pipe 102. The vanes 122 are each set at angles increasing through the depth of the vane from inlet to outlet. This arrangement serves to swirl inner secondary air as it flows past the vanes 122 to the outlet side of the windbox (WD).

It will be appreciated that inner secondary air flowing into the perforations 115 of the inner secondary air pipe 107 enters the inner secondary air plenum 104 at the end of the inner secondary air pipe. The air then travels into the inner secondary air plenum 104 where it can freely enter the fixed spinner 125 at the inner secondary air outlet 123 or exit through the perforations 118 in the perforated plate 116.

The burner nozzle socket 124 of the burner nozzle 138 includes a first mounting point 141 at its inlet edge 144 while the upstream burner barrel 136 includes a second mounting point 148 near its outlet edge 150. The outlet edge 150 of the burner barrel 136 fits within the burner nozzle socket 124 of the burner nozzle 138 such that the first mounting point 141 and second mounting point 148 align. The two mounting points serve as the first axis of rotation 114, discussed earlier with respect to FIG. 1, whereby the burner nozzle 138 and inner secondary air outlet 123 may tilt or rotate with respect to the fixed burner barrel 136. It will be appreciated that a second mount point, on the opposite sides of the burner barrel and burner nozzle 136, 138, is also provided.

FIG. 6 depicts a cross sectional view of the burner barrel 136 at the first axis of rotation 114. Here, it is shown that the burner nozzle 138 surrounds the burner barrel 136, generally at the burner nozzle socket 124 of the burner nozzle. The burner nozzle 138 includes bosses 117 with apertures (not shown) through which a pin 119 may be driven. The burner barrel 136 includes second mounting point 148, in the form of an aperture. The pins 119 therefore are driven from the outside of the burner nozzle 138 through the burner barrel 136, with the head 121 remaining on the outside. Preferably, the end of the pin opposite the head is flush with the inner surface of the burner barrel 136. This arrangement limits wear on the pin from the flowing fuel mixture.

Moving back to FIG. 1, there are also shown a pair of outer secondary air buckets 152a, 152b connected to the second frame 108, directly or indirectly, on either side of the outlet 130 such that they are situated above and below the outlet 130 in the furnace. Preferably the outer secondary air buckets have rectangular outlets 154a, 154b. Other shapes such as circular may also be provided.

The outer secondary air buckets 152a, 152b permit the passing of outer secondary air. In some embodiments, the inner secondary air and outer secondary air may emanate from the same source, but be separated early in the flow process by a divider plate acting as a flow divider (DP). In other embodiments they may not be split until later at the respective entries of the outer secondary air buckets 152a, 152b and inner secondary air outlet 123.

The outer secondary air buckets 152a, 152b are mounted to the second frame 108 via mounting points 156a, 156b forming a second axis of rotation and third axis of rotation, respectively. These axes of rotation permit the outer secondary air buckets 152a, 152b to tilt or rotate with respect to the frame 108. This tilting of the secondary air buckets 152a, 152b may be conducted in unison or individually, and also may be in unison with the tilting of the burner nozzle 138 and inner secondary air outlet 123 about the first axis of rotation 114, or not.

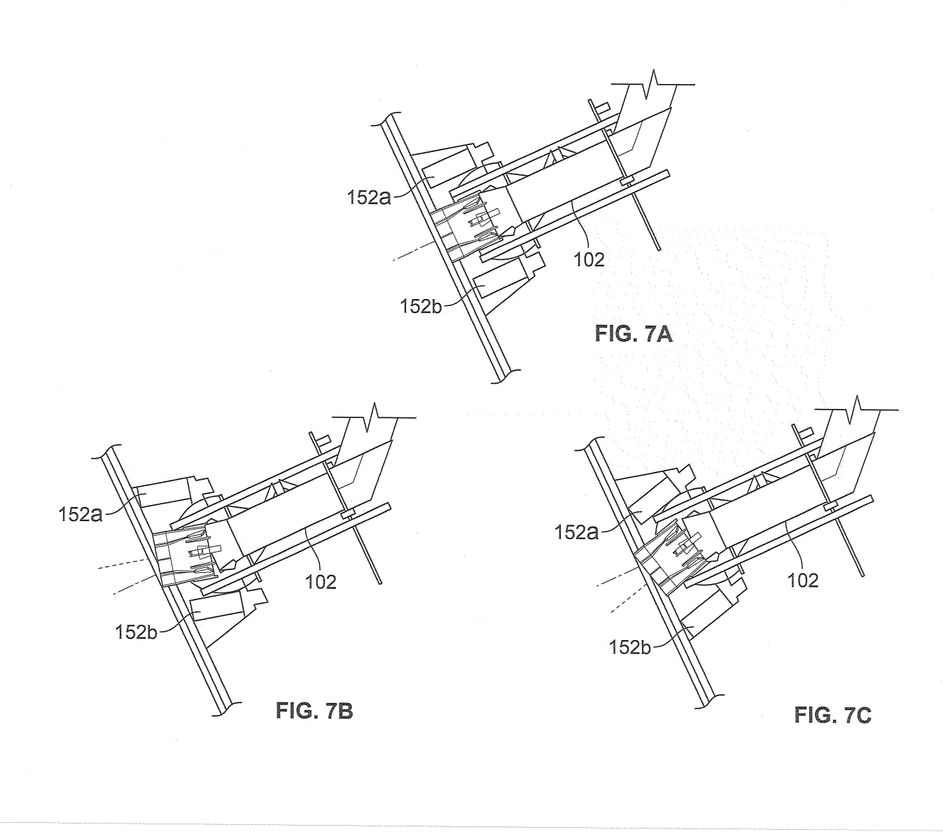

Tilting of the various components is preferably permitted within a range of 0° to approximately 20°, with 15° being typical. Representative views of the components tilted at tilt angles are shown in FIGS. 7A through 7C. Specifically, FIG. 7A depicts the outer secondary air buckets 152a, 152b and burner nozzle 138 and inner secondary air outlet 123 in the neutral position, essentially at a 0° offset angle. If tilting is required in a positive or upward direction, the outer secondary air buckets 152a, 152b and burner nozzle 138 and inner secondary air outlet 123 may be tilted as shown in FIG. 7B. Similarly, FIG. 7C depicts the components with a negative or downward tilt.

It will be appreciated that all components are tilted at the same angle in each of FIGS. 7A through 7C. However, the components may all be tilted at individual angles if so desired. These individual angles include all of the permutations possible between the options of upward, downward, and neutral, for each individual component. Moreover, these permutations include various angles within those general tilt directions. As merely and example and in no way limiting the disclosure, one possible arrangement may be for an outer secondary air bucket to be tilted 10° upward, the other outer secondary air bucket to be tilted 12° downward, and the burner nozzle 138 and inner secondary air outlet 123 tilted 7° downward. In other exemplary embodiments, the components may all be tilted 1° upward or downward, 5° upward or downward, 10° upward or downward, or 15° upward or downward. Moreover, where there are more than one burner per furnace, the different burners may have the various components oriented at different angles.

In order to perform the tilting functions of the burner, the burner 100 may be provided with a tilting mechanism or a series of tilting mechanisms. As shown in FIG. 1, an exemplary tilting mechanism may include a series of levers 400a, 400b, 400c. Such levers may be mounted to the structural steel frame 105, second frame 108, and the component to be tilted, i.e. the first outer secondary air bucket 152a, second outer secondary air bucket 152b, and inner secondary air pipe outlet 123 and burner nozzle 138 combination, and may each include an actuator 402a, 402b, 402c. In this regard, the first lever 400a may serve to tilt the first secondary outer air bucket 152a, the second lever 400b may serve to tilt the inner secondary air pipe outlet 123 and burner nozzle 138 combination, and the third lever 400c may serve to tilt the second outer secondary air bucket 152b. The actuator may be moved by known means, including mechanically moved, pneumatically moved, hydraulically moved, or electrically moved. Moreover, the levers may be arranged in known manners to convert linear motion to angular motion. For example, as shown in FIGS. 4 and 6, the lever 400b may move an ear 404 of the outer barrel 138 which is connected to the lever 400b by a pivot point 406. The ear 404 will impart a moment arm about the first axis of rotation 114, thereby tilting the burner nozzle 138. In further embodiments, one lever may be used to actuate more than one component.

Referring back to FIG. 1, there are shown curved spring plates generally adjacent to mounting points 156a, 156b. It will be appreciated that the spring plates 160a, 160b, 160c, 160d prevent uncontrolled secondary air leakage between the outer secondary air buckets 154a, 154b and inner secondary air outlet 123 and burner nozzle 138 combination. Specifically, spring plates 160a and 160d abut portions of the structural support 105 as the outer secondary air buckets 152a, 152b are rotated. Spring plates 160b and 160c abut the perforated plate 116 in a similar manner. As such, when the inner secondary air outlet 123 and burner nozzle 138 are rotated, the perforated plate 116 rides along the spring plates 160b, 160c in a sliding arrangement. The abutments of spring plates 160a, 160b, 160c, 160d with the perforated plate 116 and structural supports 105 serves to block the passage of air between the abutting members. Preferably, the perforated plate 116 is not perforated in the potential areas of contact with the spring plates 160b, 160c.

The materials of construction for the various components are preferably as would conventionally be applied for such components in a conventional horizontal burner. These materials are therefore primarily carbon steel or high grade metal alloys, such as stainless steel. Generally, any part that that is exposed to high heat or has other special needs is preferably stainless steel. Such parts include the burner nozzle 138 for its exposure to high heat and the pin 119 for its special needs. These special needs include the fact that stainless steel has a smoother surface than carbon steel and does not exhibit wear as readily. Other parts, such as the remainder of the fuel pipe 102 and structural components may be formed from carbon steel.

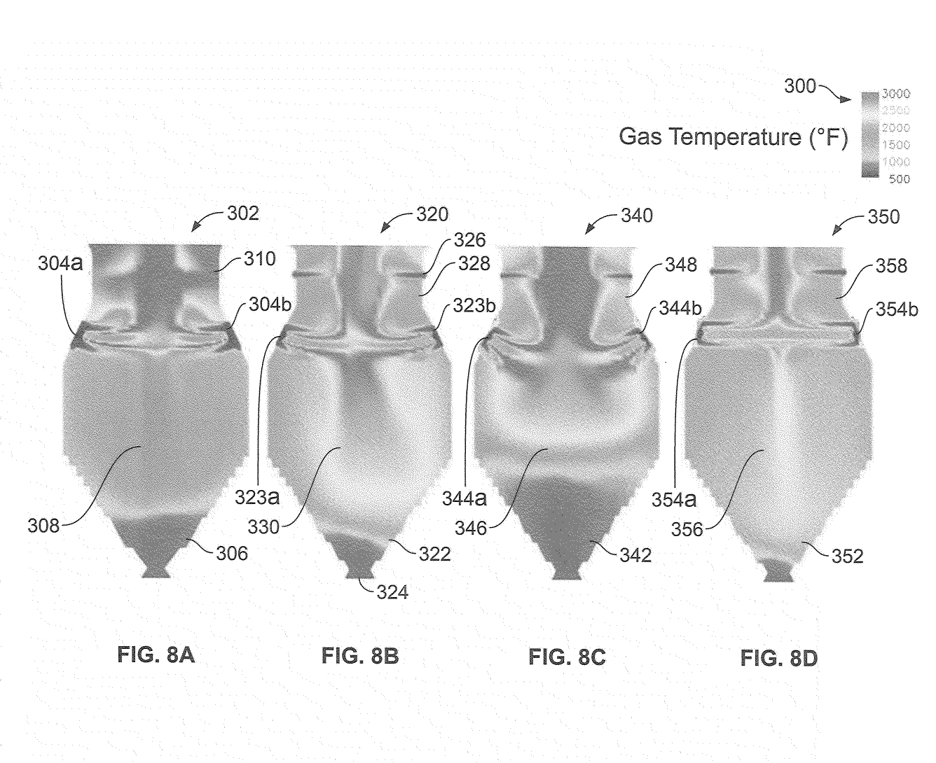

Referring to FIGS. 8A through 8D, there are shown exemplary flame temperature profiles for furnaces employing the inventive burners, with FIG. 8A representing a conventional furnace, FIG. 8B representing a conventional furnace practicing the invention of U.S. Pat. No. 5,762,007 with burners in the neutral position, FIG. 8C representing the burner of FIG. 8B with burners in the 15° down position and FIG. 8D representing the burner of FIG. 8B with burners in the 15° up position.

It will be appreciated that the flame temperature profiles of FIGS. 8A through 8D are represented in color. In accordance with the legend shown at 300, the colors represent flame temperatures from approximately 500° F., represented by the color blue, to approximately 3000° F., represented by the color red. Between, the colors range from light blue to green to yellow in increasing temperature ranges.

As previously discussed, FIG. 8A represents a flame temperature profile 302 for a conventional furnace employing conventional burners. Two such burners 304a, 304b are shown in the figure along with the outline of a conventional furnace 306. As evidenced by the flame temperature profile, the conventional burners 304a, 304b do not mix the pulverized coal and primary air efficiently, and therefore provide a flame temperature profile that extends upward above the main body 308 of the furnace. In this conventional design, the burners 304a, 304b are arranged in a neutral position, representing a near 0° tilt. Also of note is the width of the flame temperature profile at the neck 310 of the furnace 306, where it can be seen that the rising heat extends from edge to edge.

FIG. 8B depicts a flame temperature profile 320 for another conventional furnace 322 incorporating an overfire air system 326 in the neck 328, among other features. As discussed above, this furnace utilizes the teachings of U.S. Pat. No. 5,762,007 to inject the fuel air mixture through burners 323a, 323b in a neutral position, representing a near a near 0° tilt. The furnace 322 also incorporates a flue gas recirculation system, whereby flue gas is removed from the outlet end of the boiler and injected into the lower portion 324 of the furnace 322. As can be seen, given this arrangement, the flame temperature profile extends deeper into the body 330 of the furnace 322. However, the flame temperature profile 320 extending into the body 330 of the furnace 322 is of a somewhat narrow configuration, and a wider dispersion of heat would be preferable.

FIG. 8C depicts a flame temperature profile 340 for a furnace 342 also utilizing the teachings of U.S. Pat. No. 5,762,007 as well as a flue gas return system. However, this furnace 342 arrangement differs from the arrangement shown in FIG. 8B in that the burners 344a, 344b are tilted downward approximately 15°. As will be readily apparent, this tilt provides a flame temperature profile 340 which is advantageously wider and less deep within the body 346 of the furnace 342. The flame temperature profile 340 also remains well controlled in the neck area 348 of the furnace 342.

Lastly, FIG. 8D depicts a flame temperature profile 350 for a furnace 352 similar to that of FIG. 8C, except that the furnace 352 includes burners 354a, 354b tilted upward approximately 15°. Here, the flame temperature profile 350 does not penetrate deeply into the body 356 of the furnace 352, which is similar to the flame temperature profile 302 shown in FIG. 8A. However, in the flame temperature profile 350 of FIG. 8D, the flame is well controlled in the neck area 358 of the furnace 352 whereas that of FIG. 8A is not.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A horizontal fuel burner comprising:
a fuel carrier comprising a fuel barrel and a fuel nozzle, the fuel carrier transporting solid fuel and primary air to a furnace, the fuel nozzle being tiltable about a first axis of rotation formed at the junction of the fuel barrel and tiltable fuel nozzle;
an inner secondary air plenum through which the fuel carrier extends;
an inner secondary air outlet opened to said inner secondary air plenum such that inner secondary air may travel through said inner secondary air plenum into said inner secondary air outlet, the inner secondary air outlet tilting with and forming an annular space around said tiltable fuel nozzle such that inner secondary air may exit the fuel burner with solid fuel and primary air from said fuel nozzle.

2. The horizontal fuel burner of claim 1, further comprising a first outer secondary air bucket, the first outer secondary air bucket being tiltable about a second axis of rotation, and a second outer secondary air bucket, the second outer secondary air bucket being tiltable about a third axis of rotation.

3. The horizontal fuel burner of claim 2, wherein the burner nozzle and inner secondary air outlet, the first outer secondary air bucket, and the second outer secondary air bucket are each tilted at angles of between −20° and 20°.

4. The horizontal fuel burner of claim 3, wherein the burner nozzle and inner secondary air outlet, the first outer secondary air bucket, and the second outer secondary air bucket are each tilted at the same angle.

5. The horizontal fuel burner of claim 1, wherein said inner secondary air outlet is connected to a perforated plate, the perforated plate having perforations, the perforations permitting inner secondary air to exit the horizontal fuel burner.

6. The horizontal fuel burner of claim 5, wherein said perforated plate is curved within said frame, the horizontal fuel burner further comprising spring plates against which the curved perforated plate may ride during movement thereof.

7. The horizontal fuel burner of claim 6, wherein said perforated plate is not perforated in portions that may contact said spring plates.

8. The horizontal fuel burner of claim 2, wherein said second outer secondary air bucket is mounted to a frame on an opposite side of said burner nozzle from said first outer secondary air bucket.

9. The horizontal fuel burner of claim 1, further comprising a tilting mechanism for tilting at least one of said burner nozzle and said inner secondary air outlet, first outer secondary air bucket, and second outer secondary air bucket.

10. The horizontal burner of claim 1, wherein said fuel nozzle includes a center pipe mounted therein, the center pipe providing a separate path for fuel and primary air to flow within the fuel nozzle.

11. The horizontal burner of claim 1, further comprising an inner secondary air pipe surrounding said fuel barrel such that an annular space is created therebetween, the inner secondary air pipe including a perforated section permitting air to enter the annular space;
wherein the inner secondary air pipe extends to the inner secondary air plenum to provide inner secondary air thereto.

12. The horizontal burner of claim 11, further comprising a collar slidably engaged to said inner secondary air pipe for adjusting the exposed surface area of the perforated section.

13. The horizontal burner of claim 1, further comprising spring plates associated with said first axis of rotation.

14. The horizontal burner of claim 13, wherein inner secondary air is prevented from passing said spring plates.

15. A method of assembling a horizontal burner comprising:
mounting an inner secondary air outlet with internal fuel nozzle to a fuel carrier at a first axis of rotation such that the inner secondary air outlet and fuel nozzle may tilt with respect to the fuel carrier about the first axis of rotation,
mounting a first outer secondary air bucket to the frame at a second axis of rotation such that the first outer secondary air bucket may tilt with respect to the frame about the second axis of rotation;
mounting a second outer secondary air bucket to the frame at a third axis of rotation such that the second outer secondary air bucket may tilt with respect to the frame about the third axis of rotation.

16. The method of assembling a burner of claim 15, further comprising attaching a tilt mechanism for tilting at least one of the inner secondary air pipe, first outer secondary air bucket, and second outer secondary air bucket.

17. The method of assembling a burner of claim 15, further comprising mounting a secondary air plenum to said frame such that air may flow from the inner secondary air plenum to the inner secondary air outlet.

18. A boiler system comprising:
a furnace;
a plurality of horizontal burners supplying fuel and air to said furnace, said plurality of burners each comprising:
a fuel carrier comprising a fuel barrel and a tiltable fuel nozzle, the fuel nozzle being tiltable about an end portion of the fuel barrel;
an inner secondary air plenum through which the fuel carrier extends;
an inner secondary air outlet open to said inner secondary air plenum, the inner secondary air outlet surrounding said fuel nozzle and being tiltable therewith.

19. The boiler system of claim 18, further comprising:
first and second outer secondary air buckets, said first and second outer secondary air buckets being tiltable.

20. The boiler of claim 19, wherein said first and second outer secondary air buckets are tiltably mounted above and below said fuel nozzle, respectively, within the furnace.

21. A burner nozzle for a solid fuel furnace, said burner nozzle comprising:
an inlet end and an outlet end, said outlet end forming a plurality of lobes;
an inner pipe mounted between said inlet end and said outlet end, said inner pipe forming an annular space with said burner nozzle;
whereby fuel and air may pass both within said annular space and said inner pipe.
